(19) United States
(12) Patent Application Publication
(10) Pub. No.: US 2026/0208533 A1
(43) Pub. Date: Jul. 23, 2026

(54) BICYCLE WHEEL AND BICYCLE TIRE

(71) Applicant: INNOVA RUBBER CO., LTD., CHANGHUA CITY (TW)

(72) Inventors: HSI-MING HSIEH, CHANGHUA CITY (TW); YU-REN LIU, CHANGHUA CITY (TW)

(73) Assignee: INNOVA RUBBER CO., LTD., CHANGHUA CITY (TW)

(21) Appl. No.: 19/387,342

(22) Filed: Nov. 12, 2025

(30) Foreign Application Priority Data
Jan. 17, 2025 (TW) 114200679

(51) Int. Cl. B60C 3/04; B60B 21/02; B60C 9/08; B60C 9/20

(52) U.S. Cl. CPC B60C 3/04; B60B 21/02; B60C 9/08; B60C 9/20; B60C 2009/2016; B60C 2009/2019; B60C 2200/12

(57) ABSTRACT

A bicycle wheel includes a rim, and a bicycle tire having a tire body, a tread layer having a ground-contact surface, and a belt disposed around the tire body and located between the tire body and the tread layer. An included angle between cords of the tire body and an imaginary equatorial line is between 70 and 90 degrees, and an included angle between cords of the belt and the imaginary equatorial line is between 0 and 40 degrees. A ratio of a tire height to a tire width is less than or equal to 0.8, and a ratio of an inner rim width of the rim to the tire width is greater than or equal to 0.75. Accordingly, the bicycle tire and the bicycle wheel provide excellent comfort, maneuverability, and high-speed performance.

### BACKGROUND OF THE INVENTION

### 1. Field of the Invention

The present invention relates to bicycle tires and wheels, and more particularly to a bicycle tire and a bicycle wheel that provide excellent comfort, maneuverability, and high-speed performance.

### 2. Description of the Related Art

Conventional bicycle tires have long faced the issue of being unable to achieve comfort, maneuverability, and high-speed performance simultaneously. Even though significant progress has been made in the development of lightweight materials and tread designs, and tubeless bicycle tires have been developed, the trade-off remains that better comfort usually results in poorer maneuverability and high-speed performance.

In the conventional design concept of bicycle tires, the tire width and tire height defined in a cross-section of the tire are approximately equal, and the inner rim width of the matching rim is less than 60% of the tire width, resulting in a cross-sectional shape resembling an inflated balloon. In addition, the tire typically adopts a bias-ply structure, in which the cords of the tire body form an included angle of about 40-50 degrees with the tire's equatorial line, providing higher stiffness and thus good maneuverability but poor riding comfort. Although some tires are designed so that the cords of the tire body form an included angle of 65-90 degrees with the equatorial line, i.e., as radial or semi-radial tires, to improve comfort, such designs lead to insufficient turning support due to weaker tire body strength, causing wobbling that adversely affects maneuverability and reduces high-speed stability. Consequently, such tires have not been widely accepted in the market.

### SUMMARY OF THE INVENTION

The present invention has been accomplished in view of the above-noted circumstances. An objective of the present invention is to provide a bicycle tire and a bicycle wheel that achieve excellent comfort, maneuverability, and high-speed performance.

To achieve the above objective, the present invention provides a bicycle wheel comprising a bicycle tire and a rim. The bicycle tire defines an imaginary equatorial line and comprises a tire body, a tread layer covering the tire body, and a belt disposed around the tire body and located between the tire body and the tread layer. The tire body includes a plurality of cords defining with the imaginary equatorial line an included angle greater than or equal to 70 degrees and less than or equal to 90 degrees. The tread layer has a ground-contact surface configured for contacting a ground, and the belt is positioned corresponding to the ground-contact surface. The belt has a plurality of cords defining with the imaginary equatorial line an included angle greater than or equal to 0 degrees and less than or equal to 40 degrees. In a cross-section of the bicycle tire, a tire width and a tire opening opposite to the ground-contact surface are defined, a maximum distance between the tire opening and the ground-contact surface is defined as a tire height, and a ratio of the tire height to the tire width is less than or equal to 0.8. The bicycle tire includes two bead portions defining the tire opening. The rim has a tire mounting opening, and the two bead portions of the bicycle tire are mounted to the tire mounting opening of the rim. The tire mounting opening of the rim defines an inner rim width, and a ratio of the inner rim width to the tire width is greater than or equal to 0.75.

With the technical feature that the cords of the tire body define with the imaginary equatorial line an included angle between 70 and 90 degrees, the tire body is formed as a radial or semi-radial tire body. Such a structure provides a relatively flexible tire body that enhances riding comfort. With the technical feature that the belt having cords defining an included angle between 0 and 40 degrees with the imaginary equatorial line, the rolling resistance of the tire is reduced while the lateral traction of the tire is improved, thereby enhancing maneuverability and high-speed performance. In addition, since the ratio of the tire height to the tire width (also referred to as the aspect ratio) is less than or equal to 0.8, the cross-sectional shape of the bicycle tire is flatter than that of conventional round-shaped tires. This increases the ground-contact area of the tire, stabilizing cornering and improving maneuverability while also reducing the pressure transmitted from ground vibrations to further enhance riding comfort. Furthermore, the smaller tire height reduces the soft-tire effect of the radial or semi-radial structure and shortens the transmission distance of road feedback, resulting in quicker steering response during riding. Moreover, since the ratio of the inner rim width to the tire width is greater than or equal to 0.75, the combination of this tire specification and rim specification prevents the tire from being excessively compressed laterally when mounted on the rim, allowing the tire to substantially maintain its aspect ratio. A rim with a larger inner rim width enhances the advantages of the low-profile tire, improving the tire's elasticity without causing wobbling, thereby providing the bicycle wheel with excellent comfort, maneuverability, and high-speed performance.

To achieve the above objective, the present invention further provides a bicycle tire that defines an imaginary equatorial line and comprises a tire body, a tread layer covering the tire body, and a belt disposed around the tire body and located between the tire body and the tread layer. The tire body includes a plurality of cords defining with the imaginary equatorial line an included angle greater than or equal to 70 degrees and less than or equal to 90 degrees. The tread layer has a ground-contact surface configured for contacting a ground, and the belt is positioned corresponding to the ground-contact surface. The belt has a plurality of cords defining with the imaginary equatorial line an included angle greater than or equal to 0 degrees and less than or equal to 40 degrees. In a cross-section of the bicycle tire, a tire width, a tire opening opposite to the ground-contact surface, and a tire opening width defined by the tire opening are defined. A maximum distance between the tire opening and the ground-contact surface is defined as a tire height, and a ratio of the tire height to the tire width is less than or equal to 0.8. The tire opening width is configured in such a way that the bicycle tire is mountable on a rim having a specification that a ratio of an inner rim width of the rim to the tire width is greater than or equal to 0.75.

Accordingly, the bicycle tire provided by the present invention can be mounted on a rim having a large inner rim width, particularly a rim having a specification that the ratio of the inner rim width to the tire width is greater than or equal to 0.75, thereby increasing the ground-contact area and improving traction. By combining the design advantages of the aforementioned components, the bicycle tire of the present invention achieves excellent comfort, maneuverability, and high-speed performance.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view illustrating a part of a bicycle tire according to a preferred embodiment of the present invention;

FIG. 2 is a schematic cross-sectional view of the bicycle tire according to the preferred embodiment of the present invention;

FIG. 3 is an enlarged view of the portion A in FIG. 2;

FIG. 4 is a top view of the bicycle tire shown in FIG. 1; and

FIG. 5 is a schematic cross-sectional view of a bicycle wheel according to the preferred embodiment of the present invention.

### DETAILED DESCRIPTION OF THE INVENTION

First of all, it is should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

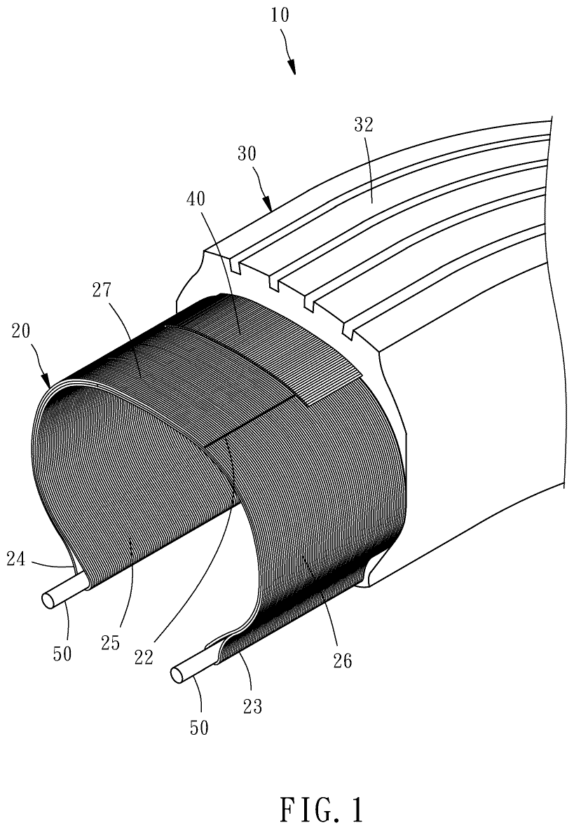

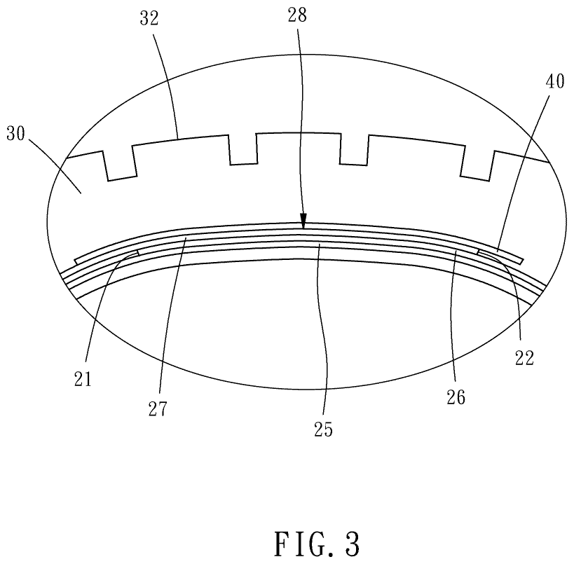

Referring to FIGS. 1 to 4, a bicycle tire 10 provided by a preferred embodiment of the present invention comprises a tire body 20, a tread layer 30, a belt 40, and two bead cores 50.

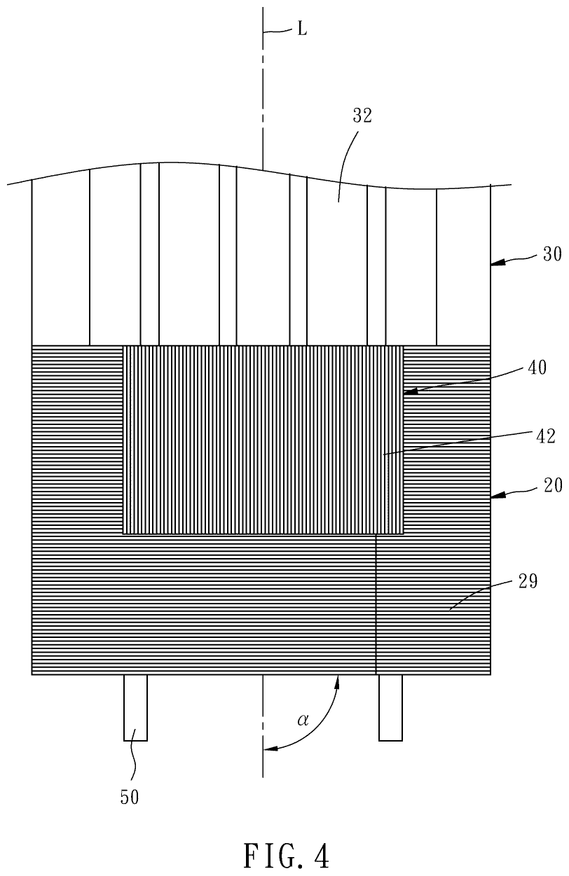

In general, the bicycle tire 10 can be defined with an imaginary equatorial line L. As shown in FIG. 4, only a segment of the equatorial line L is shown for concise illustration purposes. In practice, the equatorial line L is circular and surrounds the center of the bicycle tire 10. The tire body 20, the tread layer 30, the belt 40, and each bead core 50 extend along the equatorial line L and form annular structures. In FIGS. 1 and 4, the tire body 20, the tread layer 30, the belt 40, and the bead cores 50 are partially cut away at different positions to reveal their internal structures and the characteristic features of the present invention.

The tire body 20 is formed by coating a fiber fabric having a plurality of parallel cords 29 with rubber. The cords 29 may be made of nylon, polyester (commonly known as Tetoron), aramid fiber (commonly known as Kevlar), or other suitable materials. The tire body 20 extends arcuately and in a curled manner from a first end edge 21 to a second end edge 22, thereby forming a first folded portion 23 and a second folded portion 24 in a curled and folded shape, an inner layer 25 connecting the first folded portion 23 and the second folded portion 24, a first outer layer 26 extending from the first folded portion 23 to the first end edge 21, and a second outer layer 27 extending from the second folded portion 24 to the second end edge 22. The first outer layer 26 and the second outer layer 27 overlap each other to form a reinforced region 28. In this embodiment, the cords 29 of the tire body 20 define with the equatorial line L an included angle α equal to 90 degrees, making the tire body 20 a radial tire body. However, the tire body 20 of the present invention may also be a semi-radial tire body in which the included angle α is close to 90 degrees. More specifically, the included angle α between the cords 29 of the tire body 20 and the equatorial line L is greater than or equal to 70 degrees and less than or equal to 90 degrees. The bicycle tire 10 may also include a plurality of tire bodies 20.

The tread layer 30 is made of rubber and covers the first outer layer 26 and the second outer layer 27 of the tire body 20, and has a ground-contact surface 32 configured for contacting a ground. In this embodiment, the tread layer 30 covers only part of the first and second outer layers 26 and 27. Specifically, the tire body 20 has a first sidewall portion 51 connected to the first folded portion 23 and a second sidewall portion 52 connected to the second folded portion 24. The tread layer 30 covers the portions of the first and second outer layers 26 and 27 except for the first and second sidewall portions 51 and 52, and also covers the first folded portion 23 and the second folded portion 24. However, the tread layer 30 may alternatively be configured to completely cover the first and second outer layers 26 and 27.

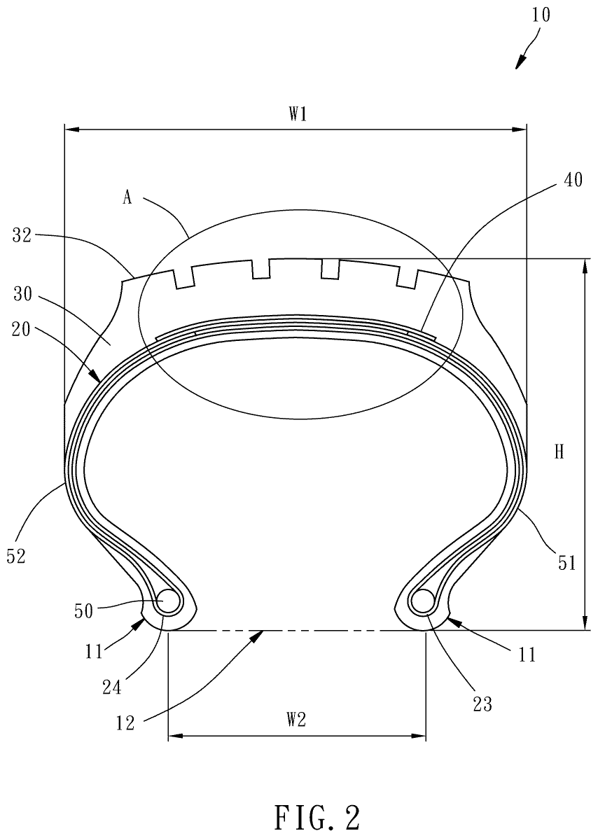

The belt 40 is formed by coating a fiber fabric having a plurality of parallel cords 42 with rubber. The cords 42 may be made of nylon, polyester, aramid, or other suitable materials. The belt 40 is disposed around the tire body 20 and located between the tire body 20 and the tread layer 30. In addition, the belt 40 is positioned corresponding to the ground-contact surface 32. More specifically, as shown in FIG. 2, the belt 40 is entirely located below the ground-contact surface 32. In this embodiment, the cords 42 of the belt 40 are parallel to the equatorial line L, i.e., the included angle between the cords 42 of the belt 40 and the equatorial line L is 0 degrees. However, the present invention is not limited thereto; the included angle between the cords 42 of the belt 40 and the equatorial line L is greater than or equal to 0 degrees and less than or equal to 40 degrees. The bicycle tire 10 may also include a plurality of belt layers 40.

In this embodiment, the overlapping position of the first and second outer layers 26 and 27 of the tire body 20 (i.e., the reinforced region 28) corresponds to the ground-contact surface 32, and the belt 40 is disposed at the reinforced region 28. However, the bicycle tire of the present invention is not limited to this configuration.

The two bead cores 50 are respectively disposed in the first folded portion 23 and the second folded portion 24 to enhance the structural strength of the bicycle tire 10. Each bead core 50 may be a thick, hard steel wire, or alternatively, each bead core 50 may include a plurality of thinner, flexible steel wires or aramid fibers and be foldable, allowing the bicycle tire 10 to be folded for convenient packaging and transportation.

As shown in FIG. 2, the bicycle tire 10 includes two bead portions 11, each of which is provided with one of the bead cores 50. The two bead portions 11 define a tire opening 12. The tire opening 12 and the ground-contact surface 32 are located at the inner and outer peripheries of the bicycle tire 10, respectively. Therefore, in the cross-section of the bicycle tire 10 (as illustrated in FIG. 2), the tire opening 12 is located opposite to the ground-contact surface 32. In the cross-section of the bicycle tire 10, a tire width W1, a tire opening width W2, and a tire height H are defined. The tire width W1 represents the maximum width of the bicycle tire 10 in the cross-section, the tire opening width W2 represents the maximum width of the tire opening 12 in the cross-section, and the tire height H represents the maximum distance between the tire opening 12 and the ground-contact surface 32 in the cross-section. A ratio of the tire height H to the tire width W1 is less than or equal to 0.8. In this embodiment, the tire opening width W2 is configured to be securely mounted on a rim having a large inner rim width (described in detail below). It should be noted that the drawings of the present invention are provided for illustrative convenience and are not necessarily drawn to scale.

In the present invention, the cords 29 of the tire body 20 define with the equatorial line L an included angle α between 70 and 90 degrees, thereby forming a radial or semi-radial tire body. Such a tire body is relatively flexible, enhancing the riding comfort of the bicycle tire 10. Furthermore, with the technical feature that the belt 40 is configured having cords 42 defining with the equatorial line L an included angle between 0 and 40 degrees, the rolling resistance of the bicycle tire 10 can be reduced, and the lateral traction can be improved, thereby enhancing maneuverability and high-speed performance.

In addition, in the present invention, the ratio of the tire height H to the tire width W1 (also referred to as the aspect ratio) is less than or equal to 0.8. Accordingly, the cross-sectional shape of the bicycle tire 10 is flatter than that of conventional round-shaped tires. This increases the ground-contact area of the bicycle tire 10, resulting in more stable cornering and improved maneuverability, while reducing the pressure transmitted from ground vibrations, thereby further enhancing riding comfort. Moreover, since the tire height H is relatively smaller, the soft-tire effect of the radial or semi-radial tire body is reduced, and the transmission distance of road feedback is shortened, allowing faster steering response during riding.

Furthermore, the specifications of the bicycle tire 10 provided by the present invention are suitable for mounting on a rim with a large inner rim width, for example, a rim having a specification that the ratio of the inner rim width to the tire width W1 is greater than or equal to 0.75, so as to increase the ground-contact area and thereby enhance traction, as described below.

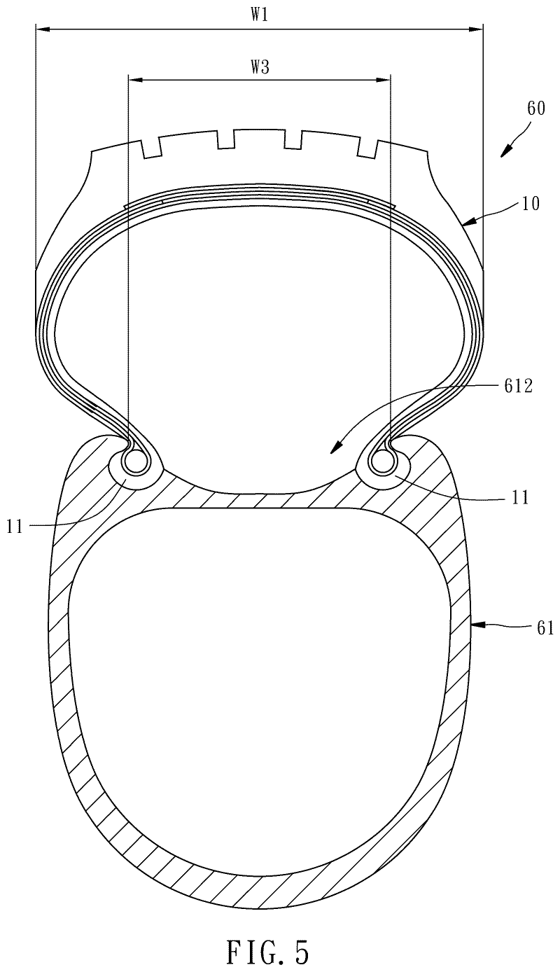

Referring to FIG. 5, this embodiment further provides a bicycle wheel 60 comprising the bicycle tire 10 as described above and a rim 61. An outer periphery of the rim 61 is provided with a tire mounting opening 612. The two bead portions 11 of the bicycle tire 10 are elastically compressed and fitted into the tire mounting opening 612 of the rim 61, thereby securing the bicycle tire 10 and the rim 61 together. The tire mounting opening 612 defines an inner rim width W3, and a ratio of the inner rim width W3 to the tire width W1 is greater than or equal to 0.75.

As a result, compared with conventional bicycle tires, under the condition that the tire width W1 is the same, the bicycle tire 10 of the present invention has a tire opening width W2 configured to match a rim 61 with a larger inner rim width W3. Through the combination of the bicycle tire 10 and rim 61 specifications (W3/W1≥0.75), the bicycle tire 10 is prevented from being excessively compressed laterally when mounted on the rim 61, ensuring that the bicycle tire 10 substantially maintains its original aspect ratio. The rim 61 with a large inner rim width allows the low-profile bicycle tire 10 to exhibit its advantages more prominently, improving the elasticity of the bicycle tire 10 without causing wobbling. Moreover, to achieve a better balance among comfort, maneuverability, and high-speed performance, it is preferable that the aspect ratio (H/W1) of the bicycle tire and rim combination be between 0.8 and 0.5, and that the ratio of the inner rim width W3 to the tire width W1 (W3/W1) be between 0.75 and 1.0.

For example, the specification label of the bicycle tire 10 of the present invention may be 52/70-559 40-45RW, in which 52 represents the tire width W1 of 52 millimeters (mm), 70 represents an aspect ratio of 70%, 559 represents an inner diameter of the tire of 559 mm, and 40-45RW represents an inner rim width W3 of 40-45 mm. The ratio of the inner rim width W3 to the tire width W1 for this specification is approximately 0.77 to 0.87. In another example, the specification label of the bicycle tire 10 may be 62/60-584 50-55RW, in which 62 represents the tire width W1 of 62 mm, 60 represents an aspect ratio of 60%, 584 represents an inner diameter of the tire of 584 mm, and 50-55RW represents an inner rim width W3 of 50-55 mm. The ratio of the inner rim width W3 to the tire width W1 for this specification is approximately 0.81 to 0.89. In addition, the specification label of the bicycle tire 10 of the present invention may also include the type of tire body. For example, 52/70SR559 40-45RW, in which “SR” indicates a semi-radial tire body (e.g., included angle α=70 degrees); or 52/70R 559 40-45RW, in which “R” indicates a radial tire body (included angle α=90 degrees).

It should be noted that, in the bicycle wheel 60 provided in the above embodiment, the bicycle tire 10 used with the rim 61 having a specification in which the ratio of the inner rim width to the tire width is greater than or equal to 0.75 (i.e., W3/W1≥0.75) is not particularly limited by the tire opening width W2. As long as the bicycle tire 10 can be securely mounted on a rim 61 having a specification that the ratio of the inner rim width to the tire width is greater than or equal to 0.75 (i.e., W3/W1≥0.75), the bicycle tire 10 can substantially maintain its original aspect ratio and fully exhibit the advantages of a low-profile tire.

In summary, in the present invention, by configuring the cords of the tire body to define with the equatorial line an included angle between 70 and 90 degrees, the cords of the belt to define with the equatorial line an included angle between 0 and 40 degrees, the ratio of the tire height to the tire width to be less than or equal to 0.8 (preferably between 0.8 and 0.5), and/or the ratio of the inner rim width to the tire width to be greater than or equal to 0.75 (preferably between 0.75 and 1.0), the design advantages of these structural features collectively provide the bicycle tire and the bicycle wheel with excellent comfort, maneuverability, and high-speed performance. The aforementioned structural design can be applied to various types of tires, and the bicycle tire of the present invention may be a TT (tube type) tire, a TL (tubeless) tire, or a TLR (tubeless ready) tire, among others.

Finally, it should be noted again that the constituent elements disclosed in the foregoing embodiments are provided by way of example and are not intended to limit the scope of the present application. Substitutions or modifications using other equivalent elements are also intended to be encompassed within the scope of the claims of this application.

What is claimed is:

1. A bicycle wheel comprising:
a bicycle tire and a rim;
the bicycle tire defining an imaginary equatorial line and comprising:
a tire body having a plurality of cords defining with the imaginary equatorial line an included angle greater than or equal to 70 degrees and less than or equal to 90 degrees;
a tread layer covering the tire body and having a ground-contact surface configured for contacting a ground; and
a belt disposed around the tire body and located corresponding to the ground-contact surface and between the tire body and the tread layer, the belt having a plurality of cords defining with the imaginary equatorial line an included angle greater than or equal to 0 degrees and less than or equal to 40 degrees;
wherein, in a cross-section of the bicycle tire, a tire width and a tire opening that is opposite to the ground-contact surface are defined, a maximum distance between the tire opening and the ground-contact surface is defined as a tire height, and a ratio of the tire height to the tire width is less than or equal to 0.8;
wherein the bicycle tire includes two bead portions defining the tire opening;
wherein the rim has a tire mounting opening, and the two bead portions of the bicycle tire are mounted to the tire mounting opening of the rim;
wherein the tire mounting opening of the rim defines an inner rim width, and a ratio of the inner rim width to the tire width is greater than or equal to 0.75.

2. The bicycle wheel as claimed in claim 1, wherein the ratio of the tire height to the tire width is between 0.8 and 0.5, and the ratio of the inner rim width to the tire width is between 0.75 and 1.0.

3. The bicycle wheel as claimed in claim 2, wherein the tire width is 52 millimeters; the ratio of the tire height to the tire width is equal to 0.7; the tire has an inner diameter of 559 millimeters, and the ratio of the inner rim width to the tire width is between 0.77 and 0.87.

4. The bicycle wheel as claimed in claim 2, wherein the tire width is 62 millimeters; the ratio of the tire height to the tire width is equal to 0.6; the tire has an inner diameter of 584 millimeters, and the ratio of the inner rim width to the tire width is between 0.81 and 0.89.

5. The bicycle wheel as claimed in claim 1, wherein the tire body has a first end edge and a second end edge, and extends in an arcuate and curled manner from the first end edge to the second end edge to form a first folded portion and a second folded portion in a curled and folded shape, an inner layer connecting the first folded portion and the second folded portion, a first outer layer extending from the first folded portion to the first end edge, and a second outer layer extending from the second folded portion to the second end edge;
wherein the first outer layer and the second outer layer overlap each other, and the tread layer covers the first outer layer and the second outer layer of the tire body.

6. The bicycle wheel as claimed in claim 5, wherein the belt is disposed at an overlapping position of the first outer layer and the second outer layer of the tire body.

7. The bicycle wheel as claimed in claim 5, wherein the bicycle tire further comprises two bead cores disposed in the first folded portion and the second folded portion, respectively; each of the bead cores is foldable.

8. A bicycle tire defining an imaginary equatorial line, the bicycle tire comprising:
a tire body having a plurality of cords defining with the imaginary equatorial line an included angle greater than or equal to 70 degrees and less than or equal to 90 degrees;
a tread layer covering the tire body and having a ground-contact surface configured for contacting a ground; and
a belt disposed around the tire body and located corresponding to the ground-contact surface and between the tire body and the tread layer, the belt having a plurality of cords defining with the imaginary equatorial line an included angle greater than or equal to 0 degrees and less than or equal to 40 degrees;
wherein, in a cross-section of the bicycle tire, a tire width, a tire opening opposite to the ground-contact surface, and a tire opening width defined by the tire opening are defined,
wherein a maximum distance between the tire opening and the ground-contact surface is defined as a tire height, and a ratio of the tire height to the tire width is less than or equal to 0.8;
wherein the tire opening width of the bicycle tire is configured to fit a rim having an inner rim width, and a ratio of the inner rim width to the tire width is greater than or equal to 0.7.

9. The bicycle tire as claimed in claim 8, wherein the tire body has a first end edge and a second end edge, and extends in an arcuate and curled manner from the first end edge to the second end edge to form a first folded portion and a second folded portion in a curled and folded shape, an inner layer connecting the first folded portion and the second folded portion, a first outer layer extending from the first folded portion to the first end edge, and a second outer layer extending from the second folded portion to the second end edge;
wherein the first outer layer and the second outer layer overlap each other, and the tread layer covers the first outer layer and the second outer layer of the tire body.

10. The bicycle tire as claimed in claim 9, wherein the belt is disposed at an overlapping position of the first outer layer and the second outer layer of the tire body.

11. The bicycle tire as claimed in claim 9, further comprising two bead cores disposed in the first folded portion and the second folded portion, respectively; each of the bead cores is foldable.

12. The bicycle tire as claimed in claim 8, wherein the ratio of the tire height to the tire width is between 0.8 and 0.5, and the ratio of the inner rim width to the tire width is between 0.75 and 1.0.

13. The bicycle tire as claimed in claim 12, wherein the tire width is 52 millimeters; the ratio of the tire height to the tire width is equal to 0.7; the tire has an inner diameter of 559 millimeters, and the ratio of the inner rim width to the tire width is between 0.77 and 0.87.

14. The bicycle tire as claimed in claim 12, wherein the tire width is 62 millimeters; the ratio of the tire height to the tire width is equal to 0.6; the tire has an inner diameter of 584 millimeters, and the ratio of the inner rim width to the tire width is between 0.81 and 0.89.
